(19) United States
(12) Patent Application Publication
(10) Pub. No.: US 2008/0072303 A1
(43) Pub. Date: Mar. 20, 2008

(54) METHOD AND SYSTEM FOR ONE TIME PASSWORD BASED AUTHENTICATION AND INTEGRATED REMOTE ACCESS

(75) Inventor: Jameel Syed, Sugar Land, TX (US)

Correspondence Address: OSHA . LIANG L.L.P. / SLB, 1221 MCKINNEY STREET, SUITE 2800, HOUSTON, TX, 77010, US

(73) Assignee: SCHLUMBERGER TECHNOLOGY CORPORATION, Houston, TX (US)

(21) Appl. No.: 11/855,017

(22) Filed: Sep. 13, 2007

Related U.S. Application Data
(60) Provisional application No. 60/844,601, filed on Sep. 14, 2006.

(51) Int. Cl. H04L 9/32

(52) U.S. Cl. 726/10

(57) ABSTRACT

A system for client authentication using a one time password (OTP) including a client configured to request access to an application executing on an internal corporate network, and transmit the OTP and a user name associated with a user to an OTP keys distribution center (KDC), wherein the OTP is used to authenticate the user to the internal corporate network, and the OTP KDC configured to receive the OTP from the client, and issue an inter-domain key and a ticket-granting-ticket (TGT) to the client upon validation of the OTP, wherein the inter-domain key and the TGT are used to authenticate the client and grant access to the application.

### CROSS-REFERENCE TO RELATED APPLICATIONS

This application claims benefit under 35 U.S.C. §119(e) from Provisional Application No. 60/844,601 entitled “Method and System for One Time Password and Smart Card Authentication” filed on Sep. 14, 2006.

### BACKGROUND

Kerberos is a network authentication protocol that is designed to provide strong authentication for client/server applications by using secret-key cryptography. Most commonly, Kerberos is used as the underlying authentication protocol for the Windows® operating system. Kerberos authentication is a single sign-on protocol that typically involves three entities: a Keys Distribution Center (KDC), a client (i.e., a user), and the server with the desired service for which access is requested by the client. The KDC is a Kerberos server that stores keys associated with multiple servers and clients. The KDC is installed as part of the domain controller and performs two service functions: the Authentication Service (AS) and the Ticket-Granting Service (TGS).

When initially logging on to a network, clients must negotiate access by providing a long-term key (also called a ticket granting ticket (TGT)) in order to be verified by the AS portion of a KDC within their domain. Subsequently, the client can request other short-term keys or session keys for communication with one or more servers. Session keys are requested using the already obtained TGT. To obtain the TGT, the client logs on to a workstation (e.g., using static passwords, smart card credentials, etc.). The client is then prompted to contact the KDC, which generates the TGT using the TGS after authenticating the client's log on credentials. In the case where a client is using smart card credentials, the certificate stored on the smart card may be extracted locally and used to generate a TGT request, and the TGT request is subsequently sent to the KDC. The KDC provides the TGT to the client upon validation of the smart card certificate. Once successfully authenticated, the user is granted the TGT, which is valid for the local domain. When a client uses smart card credentials to authenticate to the KDC, the client's password is randomized and the client has no control over the password. The TGT obtained from the KDC is typically cached on the local machine in volatile memory space and used to request sessions with services throughout the network.

The client authentication with the KDC can take place using any authentication scheme, such as static passwords, PKI credentials, etc. After establishing trust with the KDC, the KDC releases the secret keys associated with the server and provides the secret keys to the client for establishing a session between the client and the server. Further, clients can obtain access to servers on different domains using the transitive properties between the different domains. The transitive property states that if Domain A has established trust with Domain B, and Domain B has established trust with Domain C, then Domain A has automatically established trust to Domain C. Using this property, a client can communicate with a server in a different domain. Initially, the client uses the TGS service of the KDC located in Domain A to obtain a referral ticket for a second KDC located in Domain B. Subsequently, the referral ticket with the TGS service on the KDC in Domain B is used to obtain a second referral ticket for Domain C. Then, the second referral ticket is used with the TGS service on the KDC for Domain C to obtain a session ticket for the server in Domain C.

In some instances, a client may attempt to log on (using smart card credentials) to a remote terminal server. In this case, some of the layers of the stack that are used to perform the extraction and authentication of the smart card certificate are located on the terminal server, while other layers of the stack are located on the local client machine. In some cases, this may cause delays in the log on and subsequent unlocking of a user session.

### SUMMARY

In general, in one aspect, the invention relates to a system for client authentication using a one time password (OTP), comprising a client configured to request access to an application executing on an internal corporate network, and transmit the OTP and a user name associated with a user to an OTP keys distribution center (KDC), wherein the OTP is used to authenticate the user to the internal corporate network, and the OTP KDC configured to receive the OTP from the client, and issue an inter-domain key and a ticket-granting-ticket (TGT) to the client upon validation of the OTP, wherein the inter-domain key and the TGT are used to authenticate the client and grant access to the application.

In general, in one aspect, the invention relates to a method for client authentication using a one time password (OTP), comprising receiving the OTP from a client, wherein the OTP is used to authenticate a user to the internal corporate network, validating the OTP, issuing an inter-domain key and a ticket-granting-ticket (TGT) to the client upon validation of the OTP, requesting a service ticket using the TGT and the inter-domain key, and establishing communication with a corporate server executing an application on the internal corporate network using the service ticket.

In general, in one aspect, the invention relates to a computer system, comprising a processor, a memory, a storage device, and software instruction stored in the memory for enabling the computer system under control of the processor to receive the OTP from a client, wherein the OTP is used to authenticate a user to the internal corporate network, validate the OTP, issue an inter-domain key and a ticket-granting-ticket (TGT) to the client upon validation of the OTP, request a service ticket using the TGT and the inter-domain key, and establish communication with a corporate server executing an application on the internal corporate network using the service ticket.

In general, in one aspect, the invention relates to a method for client authentication using an authentication credential, comprising receiving the authentication credential associated with a user from a client, the authentication credential is used to authenticate the user to the internal corporate network, validating the authentication credential, issuing an inter-domain key and a ticket-granting-ticket (TGT) to the client upon validation of the authentication credential, requesting a service ticket using the TGT and the inter-domain key, and establishing communication with a corporate server executing an application on the internal corporate network using the service ticket.

Other aspects of the invention will be apparent from the following description and the appended claims.

### BRIEF DESCRIPTION OF DRAWINGS

FIG. 1 depicts a system for client authentication in accordance with one or more embodiments of the invention.

FIG. 2 depicts a flow chart for client authentication in accordance with one or more embodiments of the invention.

FIG. 3 depicts a flow diagram for client authentication in accordance with one or more embodiments of the invention.

FIG. 4 depicts a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for client authentication using a one time password (OTP). Specifically, embodiments of the invention relate to obtaining a ticket-granting-ticket (TGT) from a keys distribution center (KDC) using an OTP. More specifically, one or more embodiments of the invention use cross-domain authentication and a Kerberos server that supports the use of OTPs to provide a client with access to a corporate domain server.

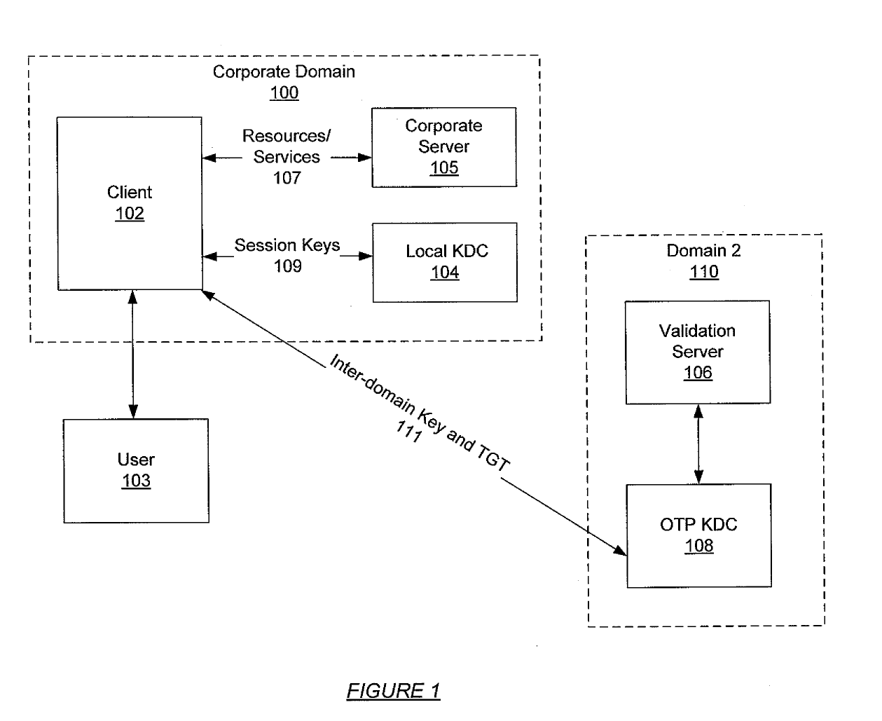

FIG. 1 depicts a system for client authentication using OTPs in accordance with one or more embodiments of the invention. Specifically, FIG. 1 depicts a client (102) associated with a user (103), a local KDC (104), and a corporate server (105) located in a corporate domain (100). Further, FIG. 1 depicts a validation server (106) and an OTP KDC (108), located in Domain 2 (110). Each of the aforementioned components of FIG. 1 is explained below.

As mentioned above, the present invention involves authentication of a user for access to a corporate network using an OTP. In one embodiment of the invention, the OTP is a randomized password that is constantly changing and is unknown to the user. In addition to the random nature of the OTP, the OTP is significantly small in size. OTPs may be generated in multiple ways. For example, an OTP may be generated using a mathematical algorithm that generates a new password based on the previous password. Alternatively, an OTP may be based on time-synchronization between the authentication server and the client/device providing the OTP. In another example, a new OTP may be generated using a mathematical algorithm based on a shared key between the authentication server and the client/device that provides the OTP and a counter independent of the previous password. Those skilled in the art will appreciate that although embodiments of the invention discuss the use of a OTP as the authentication credential to authentication a user, embodiments of the invention may be used to authenticate a user using other authentication credentials, such as biometric authentication credentials, or any other authentication credential that is small in size and can be identified as a unique identifier of a user.

In one or more embodiments of the invention, the OTP is generated using user smart card credentials. The OTP may be generated using a smart card and/or a smart card reader. For example, in one embodiment of the invention, an intelligent smart card may include the logic (i.e., a software application) configured to generate an OTP when the user inserts the smart card into a standard smart card reader. Along with the application, the smart card also includes a secret key, which is shared with the backend authentication server. Alternatively, in one or more embodiments of the invention, the software application for generating an OTP may be stored within a smart card reader. In this case, the smart card reader is an intelligent smart card reader that provides the user with an OTP when the user inserts a standard smart card into the intelligent smart card reader. In this scenario, the user's smart card only includes a secret key shared with the backend authentication server.

Those skilled in the art will appreciate that other methods for generating an OTP may exist. For example, the software application for generating an OTP may be located on the client that the user is using to log onto the corporate server or corporate network. Alternatively, in one embodiment of the invention, the software application for generating an OTP may be downloaded from a website accessed from a client. For example, suppose the user is using a third-party kiosk at a remote location to log into an internal corporate network. In this case, the user may navigate to a particular website using the kiosk, download the software application onto the kiosk, insert a smartcard or plug a smart card reader into the kiosk, and subsequently obtain an OTP from the client executing the software application.

In further embodiments of the invention, the user may carry an OTP device capable of generating an OTP when a button is pressed on the device. Such a device may be any handheld device, such as a slim card that includes OTP generating logic, etc.

Referring to FIG. 1, in one or more embodiments of the invention, a user (103) may be a real user (e.g., an individual employee associated with the corporation represented by the corporate domain (100), a consumer, etc.), or a virtual user (i.e., a batch user) that uses a client (102) to gain access to one or more services and/or resources (107) provided by the corporate server (105). The client (102) may be a kiosk, a computer, a hand-held device (e.g., a mobile phone, a personal digital assistant, a mobile media device, etc.), a thin client, or any other computing device that the user (103) uses to log into the corporate domain. In one embodiment of the invention, the user (103) accesses the corporate server (105) via the client (102). For example, a user may be an employee associated with a corporation who is traveling on business and needs to access the corporate server (105) from a kiosk (i.e., the client) at an airport. Alternatively, in one or more embodiments of the invention, the user (103) may access the corporate server (105) via a remote terminal server (not shown).

In one or more embodiments of the invention, the present invention may apply to one or more different types of client (102) systems. For example, an employee may be located at a corporate site (e.g., at work) and may wish to log into the corporate network using a local corporate machine. In this case, the client may be the local corporate computer connected to the internal corporate network. Alternatively, in one or more embodiments of the invention, a user may log into a terminal server while located at the corporate site. More specifically, an employee may wish to log into a remote terminal server located at a remote corporate site. For example, an employee located on the corporate site in Austin, Tex., may wish to log into a remote corporate server in South Africa. In this case, the client may be the remote terminal server.

In other embodiments of the invention, the client may be a handheld device, such as a media device, a mobile phone, a personal digital assistant, a kiosk, a gaming device, or any other portable/handheld electronic device with which the user may attempt to log into a corporate network. In this scenario, the employee may be located remotely from a corporate site, e.g., at an airport kiosk, at home, etc., and may wish to access the corporate network using the kiosk or handheld device. Thus, while the client is depicted as being located in the corporate domain in FIG. 1, those skilled in the art will appreciate that the client may be located in a different domain than the corporate domain. Those skilled in the art will appreciate that while the aforementioned examples specify the user as an “employee,” embodiments of the invention may apply equally to a non-employee, such as a consumer. For example, in an eBay® transaction, a consumer of eBay may use embodiments of the invention to authenticate to eBay back-end services using a smart card or an OTP authentication.

Further, in one or more embodiments of the invention, the corporate server (105) is a server associated with a corporation, which the user is attempting to access using OTP authentication. The user may wish to access resources and/or services (107) provided by the corporate server (105). The corporate server (105) may be a web server, a Lightweight Directory Access Protocol (LDAP) server, an exchange server for access to corporate e-mail, or any other type of server associated with a corporation.

As described above, the local KDC (104) may be a Kerberos server, which includes functionality to store keys associated with multiple clients and corporate servers. Further, the KDC (104) provides the client (102) with short-term/session keys (109) used to establish a session and communicate with the corporate server (105). In one embodiment of the invention, the KDC (104) provides the client (102) with short-term/session keys (109) to communicate with the corporate server (105) upon receiving a valid TGT from the client (102).

In one or more embodiments of the invention, the client (102) obtains a TGT from the OTP KDC (108). The OTP KDC (108) may be an open-source KDC that is modified to support OTP functionality. That is, the OTP KDC (108) is a Kerberos server that is modified to support OTP authentication of a user. More specifically, the OTP KDC (108) is a server that works with the underlying structure of the corporate server system. For example, if the corporate structure uses Active Directory as the underlying Windows®-based structure, then the OTP KDC (108) works together with the Active Directory infrastructure to provide corporate domain-level authentication of a user. Further, the OTP KDC (108) is located in a different domain than the client (102) and the corporate server (105). In FIG. 1, the OTP KDC (108) is located in Domain 2 (110). In one or more embodiments of the invention, trust is established between the Corporate Domain (100) and Domain 2 (110). Those skilled in the art will appreciate that inter-domain trust is established using methods well known in the art and a discussion of such methods is beyond the scope of the present invention.

Further, the OTP KDC (108) is configured to receive the OTP and user credentials from the client (102). The OTP KDC (108) is operatively connected to a validation server (106). The validation server (106) includes functionality to validate the OTP received by the OTP KDC (108). In one or more embodiments of the invention, the validation server validates the OTP using a challenge-response protocol, in which the protocol presents a question and waits for a correct answer to validate a particular piece of information. For example, a challenge-response protocol that may be employed by the validation server (106) may include a standard Remote Authentication Dial-In User Service (RADIUS) protocol, a secure sockets layer (SSL) protocol, etc.

Continuing with FIG. 1, the OTP KDC includes functionality to issue an inter-domain key and a TGT (111) to the client. The inter-domain key is a key that is used to encrypt the TGT. Further, the inter-domain key functions as the vehicle of trust between different domains. For example, if a TGT issued by the OTP KDC (108) that is encrypted by the inter-domain key can be decrypted using another inter-domain key located in a different domain, then this indicates that trust is established between the two domains. As described above, the TGT is a long-term ticket that is used to obtain service tickets/session keys (109) from the local KDC (104).

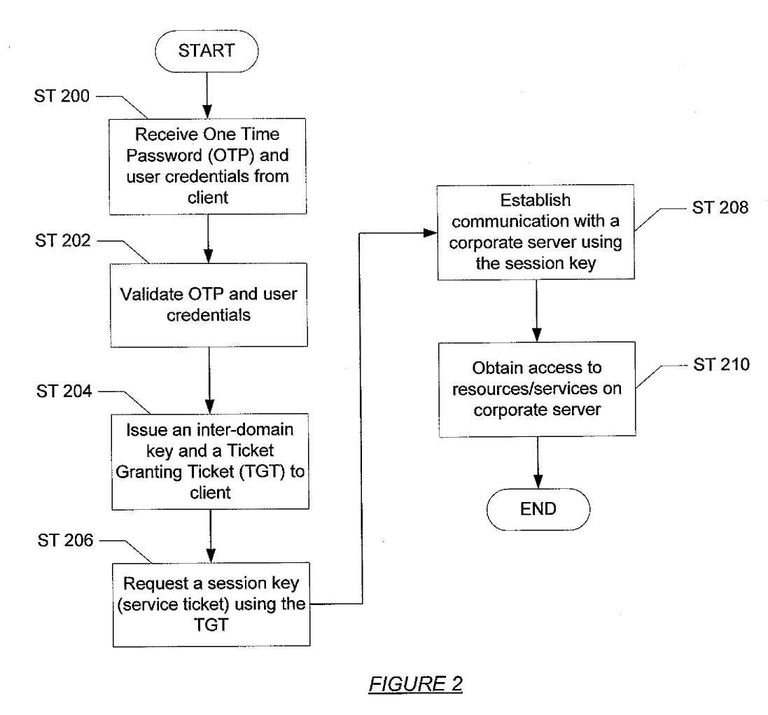

FIG. 2 depicts a flow chart describing a process for log on authentication using a one time password in accordance with one or more embodiments of the invention. Initially, an OTP and user credentials are received from a client (Step 200). As described above, the OTP may be obtained by a user that is associated with the client using a smart card and a smart card reader or using a software application that is configured to generate an OTP based on user credentials. User credentials sent by the client may include the OTP, a user name, and a domain name. Subsequently, the OTP and user credentials are validated (Step 202). Upon validation of the OTP, an inter-domain key and a TGT (111) are issued to the client (Step 204).

At this stage, the client requests a session key from the local KDC using the TGT (Step 206). That is, the client provides the TGT to the local KDC, and the KDC uses the TGT to issue a session key to the client. In one embodiment of the invention, the client uses the inter-domain key to decrypt the TGT before providing the TGT to the local KDC. Alternatively, the client may send both the inter-domain key and the TGT to the local KDC, which performs the decryption of the TGT using the inter-domain key. Upon receiving the session key (109) from the local KDC, the client uses the session key (109) to initiate communication and establish a session with a corporate server (Step 208). Finally, access to resources and/or services provided by the corporate server, such as e-mail functionality, access to internal corporate resources, etc., is obtained via the corporate server (Step 210).

In one or more embodiments of the invention, the aforementioned process may be used for gateway authentication. Gateway authentication applies when the user has access to a third-party network. Using the third-party network, the user wishes to gain access resources/services on a corporate domain. For example, a user may be using an affiliated companies' network, from which the user wishes to access resources/services on a corporate domain. In this case, the gateway (e.g., a router, a software application, etc.) associated with the corporate domain, challenges the user's OTP and other credentials such as a username and domain information. More specifically, in one embodiment of the invention, the gateway is modified to support the recognition of an OTP from the user. The web page associated with the gateway that is initially presented to the user when the user attempts to log on from the third-party network, prompts the user for a domain name, an OTP, and a usemame. Subsequently, the gateway requests authentication of the user from the backend authentication server. Alternatively, in one or more embodiments of the invention, the gateway may obtain the OTP and credentials directly from the smart card. In this case, the user may input a pin number (or any other type of identifier that unlocks the user credentials stored on the smart card, such as a biometric identifier, etc.) unlocking the smart card, and the gateway may subsequently obtain the OTP and the user credentials from the unlocked smart card. Once the user is authenticated, the gateway acts as a Kerberos proxy agent between the user and any corporate resource/service the user is attempting to access. For example, a corporate resource/service may be a service hosted on an Internet Information Service (IIS) web server or a Citrix terminal server. At this stage, from the user's perspective, the user may access any resource/service on the corporate domain without re-authenticating because the gateway acts as a Kerberos proxy agent and takes care of the authentication calls for the resources/services the user attempts to access.

Those skilled in the art will appreciate that OTP authentication may be used to perform functionalities in addition to log on authentication. For example, an OTP may be used for unlocking, offline authentication, and/or password caching. Unlocking is the process by which a user's workstation is made secure for short periods of time, for example, when a user leaves his/her workstation for a short period of time. In this case, when the user locks the workstation (e.g., by pulling out the smart card), the OTP may be used to unlock the workstation upon the user's return. Offline authentication is the process by which a user logs on to his/her workstation while being disconnected from a network. In this scenario, the OTP may be used to log on the user while the user is offline. In one embodiment of the invention, offline authentication requires user credentials to be cached locally on the workstation.

From the user's perspective, the user obtains an OTP from a device such as a smart card or another type of OTP generating device, e.g., an OTP based token. Alternatively, a user may obtain an OTP using a display card (e.g., a credit card looking plastic device) that displays generated OTPs on the face of the card. In one or more embodiments of the invention, the user is required to provide a personal identification number (PIN) (or some other type of unique identifier) to generate an OTP. In the case of the smart card generated OTP, the smart card may be enabled with an OTP application for generating an OTP. In addition, the smart card may include a private memory space with a shared key and a counter stored in the private memory space. When a user enters a correct PIN, the OTP application uses the PIN to unlock the shared key and the counter from the private memory space. The OTP application then executes the algorithm and returns the next OTP to the user. Alternatively, when an OTP is generated by a token or a display card, the shared key and the counter are embedded into the circuitry of the token/display card, and thus, the OTP can be displayed to the user by the click of a button on the token/display card.

In one or more embodiments of the invention, the user provides the OTP and a user name when logging onto an authenticating entity on the client device. The authenticating entity may be a dialog box that is displayed on the client device which prompts the user for a user name. For example, in a Windows®-based client system, the authenticating entity may be Graphical Identification and Authentication (GINA). The authenticating entity may be on the local client device or a terminal server, depending on what type of client the user is authenticating from. In either case, the authenticating entity is modified to support OTP authentication, which improves the latency in authentication of the user. In this case where a user uses a smart card to provide the OTP to the authenticating entity, the OTP credential extraction from the smart card is handled in fewer calls between the authenticating entity and the smart card logic. In the case where the OTP is obtained using devices in which the shared key and counter are embedded in the circuitry of the device, the aforementioned transaction calls are eliminated because the OTP is generated locally by a click of a button on the device.

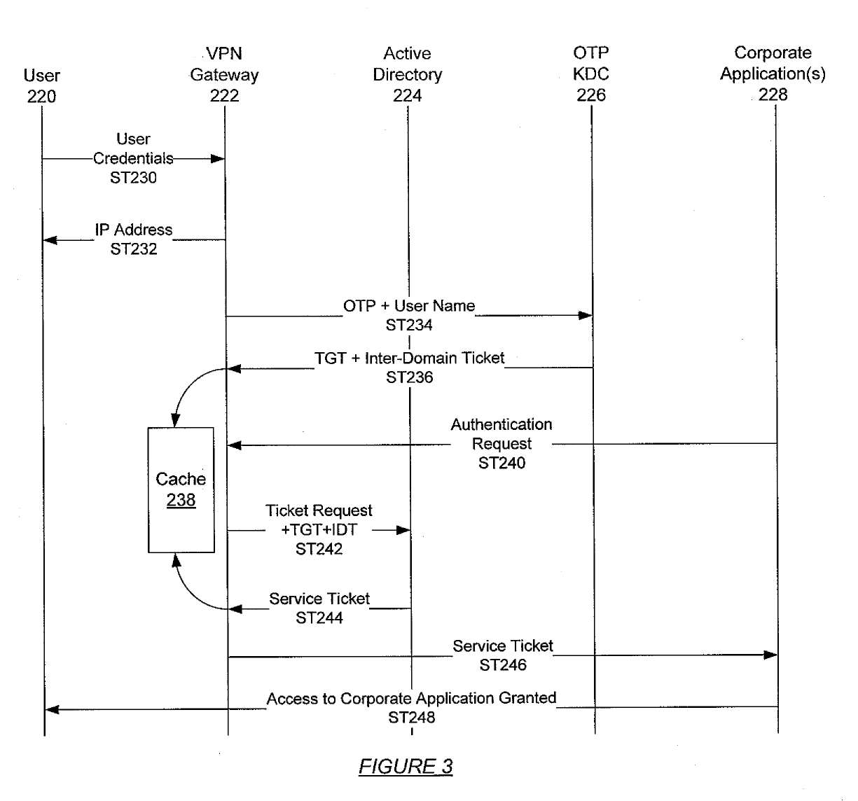

FIG. 3 depicts an example flow diagram in accordance with one or more embodiments of the invention. Specifically, the flow diagram provides a detailed overview of client authentication to an internal corporate network in accordance with one or more embodiments of the invention. FIG. 3 depicts five entities involved in the authentication process: a user (220), a virtual private network (VPN) gateway (222), Active Directory (224), OTP KDC (226), and one or more internal corporate applications (228) to which the user is ultimately attempting to gain access.

Initially, the user (220) sends credentials to the VPN gateway (222) (ST230). Specifically, in one or more embodiments of the invention, the credentials provided by the user (220) are an OTP and a user name. At this initial step, the user may also indicate which internal corporate application the user wishes to access. The VPN gateway then obtains the corporate internal IP address and transmits the IP address to the user (220) (ST232). More specifically, the VPN gateway (222) provides the user with two IP addresses—a local IP address corresponding to the user's internet service provider (ISP), and a second internal network IP address corresponding to the internal corporate network the user is attempting to access.

At this stage, the VPN gateway (222) sends the OTP and user name provided by the user (220) to the OTP KDC (226) (ST234). The OTP KDC (226) then verifies the OTP and user name and if the user is one that is permitted access to the internal corporate network, the OTP KDC (226) issues a TGT and an inter-domain ticket and transmits the TGT and inter-domain ticket to the VPN gateway (222) (ST 236). The VPN gateway (222) subsequently caches the TGT and inter-domain ticket granted by the OTP KDC (226) in a local cache (238). The TGT issued by the OTP KDC (226) may be associated with a duration of time, e.g., a few days, a week, etc., and may be cached by the VPN gateway until the TGT duration expires. Next, the corporate application (228) to which the user requested access issues an authentication request (ST240). The authentication request is sent to the VPN gateway (222), and indicates to the VPN gateway (222) that the internal corporate application (228) requires a service ticket for access to the application to be granted to a permitted user. In one or more embodiments of the invention, the authentication request is issued by the internal corporate application (228) via a known protocol.

Continuing with FIG. 3, the VPN gateway (222) may transmit the cached TGT and inter-domain ticket, along with request for a service ticket, to the Active Directory (224) server (ST242). Those skilled in the art will appreciate that the server from which a service ticket is requested by the VPN gateway (222) may be a Kerberos-compliant server other than Active Directory. For example, the server may be an MIT Kerberos server. Active Directory (224) subsequently returns a service ticket in response to the request transmitted by the VPN gateway (222) (ST244). The service ticket may also be associated with a duration, typically eight hours, although the duration of the service ticket may be any length of time. When the service ticket is received by the VPN gateway (222), the service ticket may be cached in the local cache (238). Finally, the service ticket is sent by the VPN gateway (222) to the internal network application that the user desires to access (ST246), and access to the internal corporate application is granted to the user (ST248).

Those skilled in the art will appreciate that a single service ticket only permits a user to access the originally requested corporate application. For each additional corporate application the user wishes to access, a separate and distinct service ticket may be issued by the system described in the present invention.

Thus, in the above-described process, the user only has to provide credentials once to gain access to a corporate network and applications executing on the corporate network. Thus, embodiments of the invention provide a single sign-on experience for the user. That is, once the user sends an OTP and a user name to the VPN gateway, the remainder of the process to authenticate the user is transparent to the user. Furthermore, in one or more embodiments of the invention, the present invention provides integrated remote access. Specifically, a user needs to carry only one hand-held device (e.g., a smart card capable of providing an OTP, an OTP generating device, etc.) to obtain inter-domain level authentication and to gain access to an internal corporate network. Those skilled in the art will appreciate that the user may carry more than one device if the user desires. For example, the user may carry both an OTP generating device and a smart card.

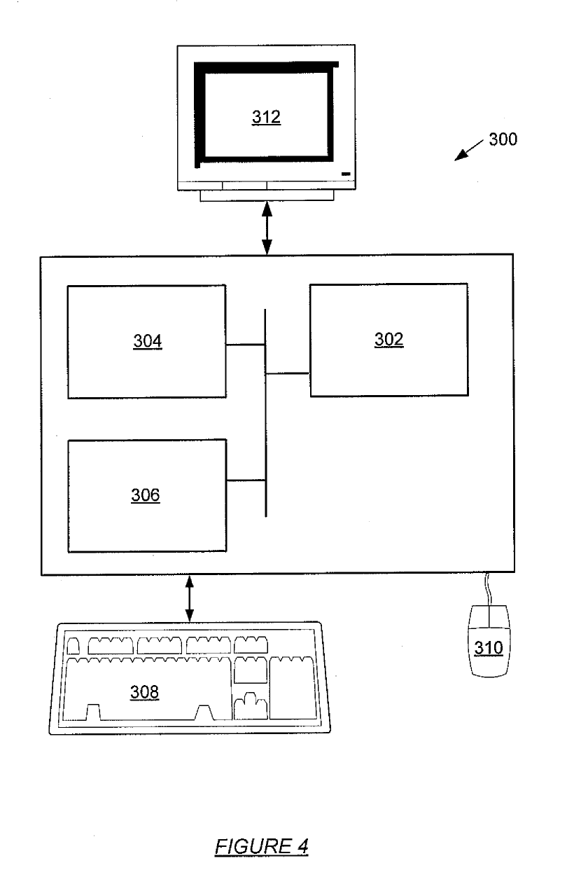

The invention may be implemented on virtually any type of computing device regardless of the platform being used. For example, as shown in FIG. 4, a computer system (300) includes a processor (302), associated memory (304), a storage device (306), and numerous other elements and functionalities typical of today's computers (not shown). The computer (300) may also include input means, such as a keyboard (308) and a mouse (310), and output means, such as a monitor (312). The computer system (300) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (300) may be located at a remote location and connected to the other elements over a network. Further, the invention may be implemented on a distributed system having a plurality of nodes, where each portion of the invention (e.g., the client, the open-source KDC Kerberos server, the validation server, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention provide a method and system for using a one time password (OTP) as an alternate type of credential for client log on and authentication to an internal corporate network. Advantageously, using embodiments of the present invention, a user is not required to keep track of passwords or perform password maintenance to obtain access to a corporate server from a remote location. The OTP may be used as an alternative to certificate authentication, for example. Because OTPs are smaller in size than smart card certificates, they are ideally suited for high-latency network authentication and for remote access. Thus, by leveraging OTPs in an authentication framework, as embodiments of the present invention describe, the time required for authentication of a user that may be in a remote location or seeking to log into a terminal server in a remote location is greatly reduced. In addition, embodiments of the invention provide a method of leveraging one time password authentication with existing corporate structures that do not provide any native flexible authentication mechanisms, and thereby do not support different types of authentication credentials. For example, the Active Directory Windows infrastructure does not support one time password or any other authentication credential.

Using the method of the present invention, a user can employ smart card log on and an OTP to authenticate to a corporate environment via the Kerberos protocol. Further, embodiments of the invention support smart card log on for a user, while improving the time required to authenticate using smart card authentication with respect to remote services. Moreover, embodiments of the invention go beyond network-level authentication to provide domain-level authentication, such that a user presenting the right set of credentials can access resources which require domain-level credentials in addition to the network-level access.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for client authentication using a one time password (OTP), comprising:
a client configured to request access to an application executing on an internal corporate network, and transmit the OTP and a user name associated with a user to an OTP keys distribution center (KDC), wherein the OTP is used to authenticate the user to the internal corporate network; and
the OTP KDC configured to receive the OTP from the client, and issue an inter-domain key and a ticket-granting-ticket (TGT) to the client upon validation of the OTP, wherein the inter-domain key and the TGT are used to authenticate the client and grant access to the application.

2. The system of claim 1, wherein the client is one selected from a group consisting of a local corporate machine, a handheld device, a computer, a kiosk, and a remote terminal server.

3. The system of claim 2, wherein the user is a remote user on an external network, and wherein the remote user, using the client, is authenticated to the application hosted by the corporate server via a single sign-on experience.

4. The system of claim 1, wherein the client comprises an authenticating entity modified to support OTP authentication, wherein the authenticating entity obtains the OTP from the user.

5. The system of claim 1, wherein the OTP is generated using one selected from a group consisting of a smart card, an OTP token, and a display card.

6. The system of claim 1, wherein the client is further configured to request access to resources and services associated with a corporate server.

7. The system of claim 1, further comprising:
a validation server operatively connected to the OTP KDC and configured to validate the OTP received from the client.

8. The system of claim 1, wherein the client is located in a first domain and the OTP KDC is located in a second domain.

9. The system of claim 8, wherein the inter-domain key is used to verify that trust is established between the first domain and the second domain.

10. The system of claim 1, further comprising:
a local keys distribution center (KDC) configured to issue a service ticket to the client, wherein the service ticket is a short-term ticket used to establish communication between the client and a corporate server executing the application.

11. The system of claim 10, wherein the TGT is encrypted using the inter-domain key, and wherein the local KDC is further configured to decrypt the TGT using the inter-domain key.

12. The system of claim 10, wherein the TGT is a long-term ticket used to obtain the service ticket from the local KDC.

13. The system of claim 1, wherein the OTP is a randomized password generated using a mathematical algorithm and a previous password.

14. The system of claim 1, wherein the user is an employee of a corporation associated with the internal corporate network, and wherein the internal corporate network is located in a third domain.

15. The system of claim 1, wherein the local KDC and the OTP KDC are Kerberos servers.

16. A method for client authentication using a one time password (OTP), comprising:
receiving the OTP from a client, wherein the OTP is used to authenticate a user to the internal corporate network;
validating the OTP;
issuing an inter-domain key and a ticket-granting-ticket (TGT) to the client upon validation of the OTP;
requesting a service ticket using the TGT and the inter-domain key; and
establishing communication with a corporate server executing an application on the internal corporate network using the service ticket.

17. The method of claim 16, further comprising:
caching the TGT, the inter-domain key, and the service ticket.

18. The method of claim 16, wherein the client is one selected from a group consisting of a local corporate machine, a handheld device, a computer, a third-party kiosk, and a remote terminal server.

19. The method of claim 18, wherein the user is a remote user on an external network, and wherein the remote user, using the client, is authenticated to the application hosted by the corporate server via a single sign-on experience.

20. The method of claim 16, wherein the client comprises an authenticating entity modified to support OTP authentication, wherein the authenticating entity obtains the OTP from the user.

21. The method of claim 16, wherein the OTP from the client is received in a second domain, and wherein the inter-domain key is used to verify that trust is established between the first domain and the second domain.

22. The method of claim 16, wherein the TGT is encrypted using the inter-domain key, and wherein a local keys distribution center (KDC) is configured to decrypt the TGT using the inter-domain key.

23. A computer system, comprising:
a processor;
a memory;
a storage device; and
software instruction stored in the memory for enabling the computer system under control of the processor to:
receive the OTP from a client, wherein the OTP is used to authenticate a user to the internal corporate network;
validate the OTP;
issue an inter-domain key and a ticket-granting-ticket (TGT) to the client upon validation of the OTP;
request a service ticket using the TGT and the inter-domain key; and
establish communication with a corporate server executing an application on the internal corporate network using the service ticket.

24. A method for client authentication using an authentication credential, comprising:
receiving the authentication credential associated with a user from a client, the authentication credential is used to authenticate the user to the internal corporate network;
validating the authentication credential;
issuing an inter-domain key and a ticket-granting-ticket (TGT) to the client upon validation of the authentication credential;
requesting a service ticket using the TGT and the inter-domain key; and
establishing communication with a corporate server executing an application on the internal corporate network using the service ticket.

25. The method of claim 24, wherein the authentication credential is one selected from a group consisting of a one-time password (OTP) and a biometric authentication credential.
